(19) United States
(12) Patent Application Publication
(10) Pub. No.: US 2011/0132519 A1
(43) Pub. Date: Jun. 9, 2011

(54) POLYOLEFIN POLYLACTIC ACID BLENDS FOR EASY OPEN PACKAGING APPLICATIONS

(75) Inventors: FENGKUI LI, Houston, TX (US); John Ashbaugh, Houston, TX (US)

(73) Assignee: Fina Technology, Inc., Houston, TX (US)

(21) Appl. No.: 13/028,384

(22) Filed: Feb. 16, 2011

Related U.S. Application Data
(63) Continuation-in-part of application No. 12/165,051, filed on Jun. 30, 2008.

(51) Int. Cl. C08L 23/06; C08L 23/12; B32B 37/16

(52) U.S. Cl. 156/60; 525/186

(57) ABSTRACT

Easy open packaging films and methods of forming the same are described herein. The films generally include a polymeric composition, wherein the polymeric composition includes an olefin based polymer and polylactic acid.

### CROSS-REFERENCE TO RELATED APPLICATIONS

This application claims the benefit of U.S. Provisional Patent Application Ser. No. 12/165,051, filed Jun. 30, 2008.

### FIELD

Embodiments of the present invention generally relate to polymeric blends including a biopolymer adapted for use in easy open packaging applications. In particular, embodiments of the invention relate to polypropylene and polylactic acid blends.

### BACKGROUND

Packaging is an important feature in selling and marketing most products. Food products, in particular, have rather stringent packaging requirements in order to preserve freshness and enhance shelf life. Certain medical devices also present strict packaging requirements in order to preserve sterility of such devices. In such applications, the package is typically vacuum-packed or gas-flushed and subsequently hermetically sealed. Although efficient packaging of products is mandatory, various aesthetic properties of a product package are also important. For example, the appearance of a product is important in appealing to consumers. Moreover, in many applications and, in particular, for food products, reusability and ease of opening of a package are also important considerations. In many applications, the ability to easily open a package will depend on the mechanical properties of the seal.

One particularly important packaging structure utilizes a peelable seal. When a package having a peelable seal is opened, a sealing layer may be peeled away from a substrate. It is desirable for such peeling to be achievable with a low and relatively constant peel force. The elastic properties of the peelable seal are such that failure of the seal does not occur from flexing and normal handling of the package.

A need exists for improved peelable packaging systems that resist leaking, provide a hermetic seal, and open easily.

### SUMMARY

Embodiments of the present invention include easy open packaging films. The films generally include a polymeric composition, wherein the polymeric composition includes an olefin based polymer and polylactic acid.

One or more embodiments include the film of the preceding paragraph, wherein the film is adhered to a substrate.

One or more embodiments include the film of any preceding paragraph, wherein the substrate is formed of an olefin based polymer.

One or more embodiments include the film of any preceding paragraph, wherein the substrate is formed of polypropylene, polyethylene and combinations thereof.

One or more embodiments include the film of any preceding paragraph, wherein the olefin based polymer includes a propylene based random copolymer.

One or more embodiments include the film of any preceding paragraph, wherein the polymeric composition includes from about 70 wt. % to about 99 wt. % olefin based polymer.

One or more embodiments include the film of any preceding paragraph, wherein the polymeric composition includes from about 1 wt. % to about 10 wt. % polylactic acid.

One or more embodiments include the film of any preceding paragraph, wherein the polymeric composition further includes a reactive modifier.

One or more embodiments include the film of any preceding paragraph, wherein the polymeric composition includes from about 1 wt. % to about 10 wt. % reactive modifier.

One or more embodiments include the film of any preceding paragraph, wherein the reactive modifier is selected from epoxy-functionalized polyolefins, PP-g-nylon, ethylene-methacrylate copolymer, SEBS, maleated SEBS, and maleated polyolefins.

One or more embodiments include a method of forming an easy open package. The method generally includes providing a polymeric composition including an olefin based polymer and polylactic acid; forming the polymeric composition into an easy open packaging film; and adhering the film to a substrate so as the film has a peelable seal to the substrate.

One or more embodiments include the method of the preceding paragraph, wherein the substrate is formed of an olefin based polymer.

One or more embodiments include the method of any preceding paragraph, wherein the substrate is formed of polypropylene, polyethylene and combinations thereof.

One or more embodiments include the method of any preceding paragraph, wherein the olefin based polymer includes a propylene based random copolymer.

One or more embodiments include the method of any preceding paragraph, wherein the olefin based polymer is selected from polypropylene, polyethylene, copolymers thereof and combinations thereof.

One or more embodiments include the method of any preceding paragraph, wherein the polymeric composition includes from about 70 wt. % to about 99 wt. % olefin based polymer.

One or more embodiments include the method of any preceding paragraph, wherein the polymeric composition includes from about 1 wt. % to about 10 wt. % polylactic acid.

One or more embodiments include the method of any preceding paragraph, wherein the polymeric composition further includes a reactive modifier.

One or more embodiments include the method of any preceding paragraph, wherein the polymeric composition includes from about 1 wt. % to about 10 wt. % reactive modifier.

### DETAILED DESCRIPTION

### Introduction and Definitions

A detailed description will now be provided. Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions when the information in this patent is combined with available information and technology.

Various terms as used herein are shown below. To the extent a term used in a claim is not defined below, it should be given the broadest definition skilled persons in the pertinent art have given that term as reflected in printed publications and issued patents at the time of filing. Further, unless otherwise specified, all compounds described herein may be substituted or unsubstituted and the listing of compounds includes derivatives thereof.

Further, various ranges and/or numerical limitations may be expressly stated below. It should be recognized that unless stated otherwise, it is intended that endpoints are to be interchangeable. Further, any ranges include iterative ranges of like magnitude falling within the expressly stated ranges or limitations.

Polymeric compositions including biodegradable components and methods of making and using the same are described herein. The polymeric compositions are generally formed of an olefin based polymer and polylactic acid.

Catalyst systems useful for polymerizing olefin monomers include any suitable catalyst system. For example, the catalyst system may include chromium based catalyst systems, single site transition metal catalyst systems including metallocene catalyst systems, Ziegler-Natta catalyst systems or combinations thereof, for example. The catalysts may be activated for subsequent polymerization and may or may not be associated with a support material, for example.

As indicated elsewhere herein, the catalyst systems are used to form olefin based polymer compositions (which may be interchangeably referred to herein as polyolefins). Once the catalyst system is prepared, as described above and/or as known to one skilled in the art, a variety of processes may be carried out using that composition to form olefin based polymers. The equipment, process conditions, reactants, additives and other materials used in polymerization processes will vary in a given process, depending on the desired composition and properties of the polymer being formed. Such processes may include solution phase, gas phase, slurry phase, bulk phase, high pressure processes or combinations thereof, for example. (See, U.S. Pat. No. 5,525,678; U.S. Pat. No. 6,420,580; U.S. Pat. No. 6,380,328; U.S. Pat. No. 6,359,072; U.S. Pat. No. 6,346,586; U.S. Pat. No. 6,340,730; U.S. Pat. No. 6,339,134; U.S. Pat. No. 6,300,436; U.S. Pat. No. 6,274,684; U.S. Pat. No. 6,271,323; U.S. Pat. No. 6,248,845; U.S. Pat. No. 6,245,868; U.S. Pat. No. 6,245,705; U.S. Pat. No. 6,242,545; U.S. Pat. No. 6,211,105; U.S. Pat. No. 6,207,606; U.S. Pat. No. 6,180,735 and U.S. Pat. No. 6,147,173, which are incorporated by reference herein.)

In certain embodiments, the processes described above generally include polymerizing one or more olefin monomers to form olefin based polymers. The olefin monomers may include C₂ to C₃₀ olefin monomers, or C₂ to C₁₂ olefin monomers (e.g., ethylene, propylene, butene, pentene, 4-methyl-1-pentene, hexene, octene and decene), for example. It is further contemplated that the monomers may include olefinic unsaturated monomers, C₄ to C₁₈ diolefins, conjugated or nonconjugated dienes, polyenes, vinyl monomers and cyclic olefins, for example. Non-limiting examples of other monomers may include norbornene, norbornadiene, isobutylene, isoprene, vinylbenzycyclobutane, styrene, alkyl substituted styrene, ethylidene norbornene, dicyclopentadiene and cyclopentene, for example. The formed polymer may include homopolymers, copolymers or terpolymers, for example.

In one or more embodiments, the olefin based polymers formed via the processes described herein may include, but are not limited to, linear low density polyethylene, elastomers, plastomers, high density polyethylenes, low density polyethylenes, medium density polyethylenes, polypropylene and polypropylene copolymers, for example.

Unless otherwise designated herein, all testing methods are the current methods at the time of filing. In one or more embodiments, the olefin based polymers include propylene based polymers. As used herein, the term “propylene based” is used interchangeably with the terms “propylene polymer” or “polypropylene” and refers to a polymer having at least about 50 wt. %, or at least about 70 wt. %, or at least about 75 wt. %, or at least about 80 wt. %, or at least about 85 wt. % or at least about 90 wt. % polypropylene relative to the total weight of polymer, for example.

The propylene based polymers may have a molecular weight distribution (Mₙ/M_{w}) of from about 1.0 to about 20, or from about 1.5 to about 15 or from about 2 to about 12, for example.

The propylene based polymers may have a melting point (Tₘ) (as measured by DSC) of at least about 110° C., or from about 115° C. to about 175° C., for example.

The propylene based polymers may include about 15 wt. % or less, or about 12 wt. % or less 12, or about 10 wt. % or less, or about 6 wt. % or less, or about 5 wt. % or less or about 4 wt. % or less of xylene soluble material (XS), for example (as measured by ASTM D5492-06).

The propylene based polymers may have a melt flow rate (MFR) (as measured by ASTM D-1238) of from about 0.01 dg/min to about 1000 dg/min., or from about 0.01 dg/min. to about 100 dg/min., for example.

In one or more specific embodiments, the propylene based polymer includes propylene based random copolymers. Unless otherwise specified, the term “propylene based random copolymer” refers to those copolymers composed primarily of propylene and an amount of at least one comonomer, wherein the polymer includes at least about 0.5 wt. %, or at least about 0.8 wt. %, or at least about 2 wt. %, or from about 0.5 wt. % to about 10.0 wt. %, or from about 0.6 wt. % to about 8 wt. % comonomer relative to the total weight of polymer, for example. The comonomers may be selected from C₂ to C₁₀ alkenes. For example, the comonomers may be selected from ethylene, propylene, 1-butene, 1-pentene, 1-hexene, 1-heptene, 1-octene, 1-nonene, 1-decene, 4-methyl-1-pentene and combinations thereof. In one specific embodinient, the comonomer includes ethylene. Further, the term “random copolymer” refers to a copolymer formed of macromolecules in which the probability of finding a given monomeric unit at any given site in the chain is independent of the nature of the adjacent units.

The propylene based random copolymers may exhibit a melt flow rate of at least about 2 dg./10 min., or from about 5 dg./10 min. to about 30 dg./10 min. or from about 10 dg./10 min. to about 20 dg./10 min., for example.

In one or more embodiments, the polymers include ethylene based polymers. As used herein, the term “ethylene based” is used interchangeably with the terms “ethylene polymer” or “polyethylene” and refers to a polymer having at least about 50 wt. %, or at least about 70 wt. %, or at least about 75 wt. %, or at least about 80 wt. %, or at least about 85 wt % or at least about 90 wt. % polyethylene relative to the total weight of polymer, for example.

The ethylene based polymers may have a density (as measured by ASTM D-792) of from about 0.86 g/cc to about 0.98 g/cc, or from about 0.88 g/cc to about 0.965 g/cc, or from about 0.90 g/cc to about 0.965 g/cc or from about 0.925 g/cc to about 0.97 g/cc, for example.

The ethylene based polymers may have a melt index (MI₂) (as measured by ASTM D-1238) of from about 0.01 dg/min to about 100 dg/min., or from about 0.01 dg/min. to about 25 dg/min., or from about 0.03 dg/min. to about 15 dg/min. or from about 0.05 dg/min. to about 10 dg/min, for example.

In one or more embodiments, the olefin based polymers include low density polyethylene. In one or more embodiments, the olefin based polymers include linear low density polyethylene. In one or more embodiments, the olefin based polymers include medium density polyethylene. As used herein, the term “medium density polyethylene” refers to ethylene based polymers having a density of from about 0.92 g/cc to about 0.94 g/cc or from about 0.926 g/cc to about 0.94 g/cc, for example.

In one or more embodiments, the olefin based polymers include high density polyethylene. As used herein, the term “high density polyethylene” refers to ethylene based polymers having a density of from about 0.94 g/cc to about 0.97 g/cc, for example.

The olefin based polymers are contacted with polylactic acid (PLA) to form the polymeric compositions including biodegradable components (which may also be referred to herein as a blend or blended material). Such contact may occur by a variety of methods. For example, such contact may include blending of the olefin based polymer and the polylactic acid under conditions suitable for the formation of a blended material. Such blending may include dry blending, extrusion, mixing or combinations thereof, for example.

The polymeric composition including biodegradable components may include at least 50 wt. %, or from about 51 wt. % to about 99 wt. %, or from about 70 wt. % to about 95 wt. % or from about 80 wt% to about 90 wt. % olefin based polymer based on the total weight of the polymeric composition, for example.

Polylactic acid is a biodegradable, thermoplastic, aliphatic polyester derived from renewable resources, such as corn starch or sugarcane. Bacterial fermentation may be used to produce lactic acid from corn starch or can sugar. However, lactic acid cannot be directly polymerized to a useful product. Instead, lactic acid is generally converted to polylactic acid.

The polylactic acid may include any polylactic acid capable of blending with an olefin based polymer. For example, the polylactic acid may be selected from poly-L-lactide (PLLA), poly-D-lactide (PDLA), poly-LD-lactide (PDLLA) and combinations thereof. The polylactic acid may be formed by known methods, such as dehydration condensation of lactic acid (see, U.S. Pat. No. 5,310,865, which is incorporated by reference herein) or synthesis of a cyclic lactide from lactic acid followed by ring opening polymerization of the cyclic lactide (see, U.S. Pat. No. 2,758,987, which is incorporated by reference herein), for example. Such processes may utilize catalysts for polylactic acid formation, such as tin compounds (e.g., tin octylate), titanium compounds (e.g., tetraisopropyl titanate), zirconium compounds (e.g., zirconium isopropoxide), antimony compounds (e.g., antimony trioxide) or combinations thereof, for example.

The polylactic acid may have a density of from about 1.238 g/cc to about 1.265 g/cc, or from about 1.24 g/cc to about 1.26 g/cc or from about 1.245 g/cc to about 1.255 g/cc (as determined in accordance with ASTM D792), for example.

The polylactic acid may exhibit a melt index (210° C., 2.16 kg) of from about 5 g/10 min. to about 35 g/10 min., or from about 10 g/10 min. to about 30 g/10 min. or from about 10 g/10 min. to about 20 g/10 min (as determined in accordance with ASTM D1238), for example.

The polylactic acid may exhibit a crystalline melt temperature (Tₘ) of from about 150° C. to about 180° C., or from about 160° C. to about 175° C. or from about 160° C. to about 170°0 C. (as determined in accordance with ASTM D3418), for example.

The polylactic acid may exhibit a glass transition temperature of from about 45° C. to about 85° C., or from about 50° C. to about 80° C. or from about 55° C. to about 75° C. (as determined in accordance with ASTM D3417), for example.

The polylactic acid may exhibit a tensile yield strength of from about 4,000 psi to about 25,000 psi, or from about 5,000 psi to about 20,000 psi or from about 5,500 psi to about 20,000 psi (as determined in accordance with ASTM D638), for example.

The polylactic acid may exhibit a tensile elongation of from about 1.5% to about 10%, or from about 2% to about 8% or from about 3% to about 7% (as determined in accordance with ASTM D638), for example.

The polylactic acid may exhibit a flexural modulus of from about 250,000 psi to about 600,000 psi, or from about 300,000 psi to about 550,000 psi or from about 400,000 psi to about 500,000 psi (as determined in accordance with ASTM D790), for example.

The polylactic acid may exhibit a notched Izod impact of from about 0.1 ft-lb/in to about 0.8 ft-lb/in, or from about 0.2 ft-lb/in to about 0.7 ft-lb/in or from about 0.4 ft-lb/in to 0.6 about ft/in (as determined in accordance with ASTM D256), for example.

The polymeric composition including biodegradable components may include from about 1 wt. % to about 49 wt. %, or from about 5 wt. % to about 30 wt. % or from about 10 wt. % to about 20 wt. % polylactic acid based on the total weight of the polymeric composition, for example.

In one or more embodiments, the polymeric composition including biodegradable components further includes a reactive modifier. The reactive modifier may be incorporated into the polymeric composition via a variety of methods. For example, the olefin based polymer and the polylactic acid may be contacted with one another in the presence of the reactive modifier. As used herein, the term “reactive modifier” refers to polymeric additives that, when added to a molten blend of immiscible polymers (e.g., the olefin based polymer and the PLA), form compounds in situ that serve to stabilize the blend. The compounds formed in situ compatibilize the blend and the reactive modifiers are precursors to these compatibilizers.

In one or more embodiments, the reactive modifier includes an epoxy-functionalized polyolefin. Examples of epoxy-functionalized polyolefins include epoxy-functionalized polypropylene, such as glycidyl methacrylate grafted polypropylene (PP-g-GMA), epoxy-functionalized polyethylene, such as polyethylene co glycidyl methacrylate (PE-co-GMA) and combinations thereof, for example.

In one or more embodiments, the reactive modifier is selected from oxazoline-grafted polyolefins, maleated polyolefin-based ionomers, isocyanate (NCO)-functionalized polyolefins and combinations thereof, for example. The oxazoline-grafted polyolefin is a polyolefin grafted with an oxazoline ring-containing monomer. In one or more embodiments, the oxazoline may include a 2-oxazoline, such as 2-vinyl-2-oxazoline (e.g., 2-isopropenyl-2-oxazoline), 2-fatty-alkyl-2-oxazoline (e.g., those obtainable from the ethanolamide of oleic acid, linoleic acid, palmitoleic acid, gadoleic acid, erucic acid and/or arachidonic acid) and combinations thereof, for example. In yet another embodiment, the oxazoline may be selected from ricinoloxazoline maleinate, undecyl-2-oxazoline, soya-2-oxazoline, ricinus-2-oxazoline and combinations thereof, for example. In yet another embodiment, the oxazoline is selected from 2-isopropenyl-2-oxazoline, 2-isopropenyl-4,4-dimethyl-2-oxazoline and combinations thereof, for example. The oxazoline-grafted polyolefin may include from about 0.1 wt. % to about 10 wt. % or from 0.2 wt. % to about 2 wt. % oxazoline, for example.

The isocyanate (NCO)-functionalized polyolefins include a polyolefin grafted with an isocyanate functional monomer. The isocyanate may be selected from TMI® unsaturated isocyanate (meta), meta and para-isopropenyl-alpha, alpha-dimethylbenzyl isocyanate; meta-isopropenyl-alpha, alpha-dimethylbenzyl isocyanate; para-isopropenyl-alpha, alpha-dimethylbenzyl isocyanate and combinations thereof, for example.

The maleated polyolefin-based ionomers include a polyolefin ionomer maleated and then neutralized with a metal component. Maleation is a type of grafting wherein maleic anhydride, acrylic acid derivatives or combinations thereof are grafted onto the backbone chain of a polymer. The metal component may be selected from sodium hydroxide, calcium oxide, sodium carbonate, sodium hydrogencarbonate, sodium methoxide, sodium acetate, magnesium ethoxide, zinc acetate, diethylzine, aluminium butoxide, zirconium butoxide and combinations thereof, for example. In one specific embodiment, the metal component is selected from sodium hydroxide, zinc acetate and combinations thereof, for example.

In one or more embodiments, the graftable polymer is a polyolefin is selected from polypropylene, polyethylene, combinations thereof and copolymers thereof.

The reactive modifiers may be prepared by any suitable method. For example, the reactive modifiers may be formed by a grafting reaction. The grafting reaction may occur in a molten state inside of an extruder, for example (e.g., “reactive extrusion”). Such grafting reaction may occur by feeding the feedstock sequentially along the extruder or the feedstock may be pre-mixed and then fed into the extruder, for example.

In one or more embodiments, the reactive modifiers are formed by grafting in the presence of an initiator, such as peroxide. Examples of initiators may include LUPERSOL® 101 and TRIGANOX® 301, commercially available from Arkema, Inc., for example.

The initiator may be used in an amount of from about 0.01 wt. % to about 2 wt. % or from about 0.2 wt. % to about 0.8 wt. % or from about 0.3 wt. % to about 0.5 wt. % based on the total weight of the reactive modifier, for example.

Alternatively, the reactive modifiers may be formed by grafting in the presence of an initiator, such as those described above, and a modifier selected from multi-functional acrylate comonomers, styrene, triacrylate esters and combinations thereof, for example. The multi-functional acrylate comonomer may be selected from polyethylene glycol diacrylate, trimethylolpropane triacrylate (TMPTA), alkoxylated hexanediol diacrylatete and combinations thereof, for example. The triacrylate esters may include trimethylopropane triacrylate esters, for example. It has unexpectedly been observed that the modifiers described herein are capable of improving grafting compared to processes absent such comonomers.

In one or more embodiments, the reactive modifier may include from about 80 wt. % to about 99.5 wt. %, or from about 90 wt. % to about 99 wt. % or from about 95 wt. % to about 99 wt. % polyolefin based on the total weight of the reactive modifier, for example.

In one or more embodiments, the reactive modifier may include from about 0.5 wt. % to about 20 wt. %, or from about 1 wt. % to about 10 wt. % or from about 1 wt. % to about 5 wt. % grafting component (i.e., the oxazoline, isocyanate, maleic anhydride, acrylic acid derivative) based on the total weight of the reactive modifier, for example.

In one or more embodiments, the reactive modifier may include from about 0.5 wt. % to about 15 wt. %, or from about 1 wt. % to about 10 wt. % or from about 1 wt. % to about 5 wt. % modifier on the total weight of the reactive modifier, for example.

The ratio of grafting component to modifier may vary from about 1:5 to about 10:1, or from about 1:2 to about 5:1 or from about 1:1 to about 3:1, for example.

In one or more embodiments, the reactive modifier may exhibit a grafting yield of from about 0.2 wt. % to about 20 wt. %, or from about 0.5 wt. % to about 10 wt. % or from about 1 wt. % to about 5 wt. %, for example. The grafting yield may be determined by Fourier Transform Infrared Spectroscopy (FTIR) spectroscopy.

The polymeric composition including biodegradable components may include from about 0.5 wt. % to about 20 wt. %, or from about 1 wt. % to about 10 wt. % or from about 3 wt. % to about 5 wt. % reactive modifier based on the total weight of the polymeric composition, for example.

In an embodiment, the polymeric composition including biodegradable components, the olefin based polymer, the polylactic acid, the reactive modifier or combinations thereof may contain additives to impart desired physical properties, such as printability, increased gloss, or a reduced blocking tendency. Examples of additives may include, without limitation, stabilizers, ultra-violet screening agents, oxidants, anti-oxidants, anti-static agents, ultraviolet light absorbents, fire retardants, processing oils, mold release agents, coloring agents, pigments/dyes, fillers or combinations thereof; for example. These additives may be included in amounts effective to impart desired properties.

The polymeric composition including biodegradable components may exhibit a melt flow rate of from about 0.5 g/10 min. to about 500 g/10 min., or from about 1.5 g/10 min. to about 50 g/10 min. or from about 5.0 g/10 min. to about 20 g/10 min, for example. (MFR as defined herein refers to the quantity of a melted polymer resin that will flow through an orifice at a specified temperature and under a specified load. The MFR may be determined using a dead-weight piston Plastometer that extrudes polypropylene through an orifice of specified dimensions at a temperature of 230° C. and a load of 2.16 kg in accordance with ASTM D1238.)

The polymeric compositions including biodegradable components are useful in applications known to one skilled in the art to be useful for conventional polymeric compositions, such as forming operations (e.g., film, sheet, pipe and fiber extrusion and co-extrusion as well as blow molding, injection molding and rotary molding). Films include blown, oriented or cast films formed by extrusion or co-extrusion or by lamination useful as shrink film, cling film, stretch film, sealing films, oriented films, snack packaging, heavy duty bags, grocery sacks, baked and frozen food packaging, medical packaging, industrial liners, and membranes, for example, in food-contact and non-food contact application. Fibers include slit-films, monofilaments, melt spinning, solution spinning and melt blown fiber operations for use in woven or non-woven form to make sacks, bags, rope, twine, carpet backing, carpet yarns, filters, diaper fabrics, medical garments and geotextiles, for example. Extruded articles include medical tubing, wire and cable coatings, sheets, such as thermoformed sheets (including profiles and plastic corrugated cardboard), geomembranes and pond liners, for example. Molded articles include single and multi-layered constructions in the form of bottles, tanks, large hollow articles, rigid food containers and toys, for example.

However, in one or more specific embodiments, the polymeric compositions are useful in easy open packaging applications (e.g., as the seal-peel layer of a package). The seal-peel layer functions to seal the container and which can be peeled off the container when the consumer desires to open the package.

Generally, easy open packaging films (referred to interchangeably herein as seal-peel layer) are formed from polyethylene including small amounts of polybutene. The easy open packaging films are generally adhered to a substrate to form a sealed package. The substrate may be formed from virtually any material used for packaging. Such materials include, but are not limited to, paper, metal foil, polymeric sheets, metalized polymeric sheets, and combinations thereof. More specific examples include, oriented or non-oriented polyester, oriented or non-oriented polypropylene, oriented or non-oriented nylon, and combinations thereof. Each of these materials may be coated or uncoated. Examples of useful coatings include, but are not limited to, varnishes, lacquers, adhesives, inks, and barrier materials (i.e., PVDC). Useful materials for packaging medical devices include high density polyolefins. However, in many embodiments described herein, the substrate is formed of a polyolefin, such as polypropylene or polyethylene.

Easy open packaging films may include carton liners, such as cereal packaging, bottles, blister packages and tray-type food packaging, including packs for pre-packed delicatessen products, such as cold meats, cheeses and smoked salmon, for example.

The embodiments described herein are capable of forming films having peel strength (e.g., seal temperature, seal strength) that can be tailored to a specific application. For example, the formed films include local areas of weak bonding with resulting substrates (due to PLA's negligible adhesion to both polypropylene and polyethylene) and areas of strong bonding (for example, local areas of polypropylene would exhibit strong bonding to substrates formed of polypropylene, while local areas of polyethylene would exhibit strong bonding to substrates formed of polyethylene). Accordingly, the peel strength of the formed films can be tailored by adjusting the components of the polymeric composition.

In one or more embodiments, the seal temperature ranges from a seal initiation temperature to a temperature that is that is at least 50° F. above the seal initiation temperature. In another embodiment, the seal temperature range is from a seal initiation temperature to a temperature that is that is at least 75° F. above the seal initiation temperature. In still another embodiment of the present invention, the seal temperature range is from a seal initiation temperature to a temperature that is at least 100° F. above the seal initiation temperature.

In one or more embodiments, the seal initiation temperature ranges from about 170° F. to about 350° F. In another embodiment, the seal initiation temperature ranges from about 170° F. to about 250° F. The term “seal initiation temperature” as used herein refers to the lowest temperature at which a seal is formed with a peel force of 0.5 lbs. per inch. Specifically, the seal initiation temperature is the temperature of a surface contacting a layer or layers that are to be sealed thereby promoting such sealing.

The term “peelable seal” as used herein means a seal that has a peel force of between 0.5 lbs per one inch of sample width and a force that tears the seal. Often, the upper limit is less than or equal to 5 lbs per inch of sample width.

The term “peelable seal temperature range” means the range of temperatures at which a seal between two materials is formed such that the peel force is between 0.5 lbs per one inch of sample width and a force that tears the seal as set forth above.

While the foregoing is directed to embodiments of the present invention, other and further embodiments of the invention may be devised without departing from the basic scope thereof and the scope thereof is determined by the claims that follow.

What is claimed is:

1. An easy open packaging film comprising a polymeric composition, wherein the polymeric composition comprises an olefin based polymer and polylactic acid.

2. An easy open package comprising the film of claim 1, wherein the film is adhered to a substrate.

3. The package of claim 2, wherein the substrate is formed of an olefin based polymer.

4. The package of claim 2, wherein the substrate is formed of polypropylene, polyethylene and combinations thereof.

5. The film of claim 1, wherein the olefin based polymer comprises a propylene based random copolymer.

6. The film of claim 1, wherein the polymeric composition comprises from about 70 wt. % to about 99 wt. % olefin based polymer.

7. The film of claim 1, wherein the polymeric composition comprises from about 1 wt. % to about 10 wt. % polylactic acid.

8. The film of claim 1, wherein the polymeric composition further comprises a reactive modifier.

9. The film of claim 8, wherein the polymeric composition comprises from about 1 wt. % to about 10 wt. % reactive modifier.

10. The film of claim 8, wherein the reactive modifier is selected from epoxy-functionalized polyolefins, PP-g-nylon, ethylene-methacrylate copolymer, SEBS, maleated SEBS, and maleated polyolefins.

11. A method of forming an easy open package comprising:
providing a polymeric composition comprising an olefin based polymer and polylactic acid;
forming the polymeric composition into an easy open packaging film; and
adhering the film to a substrate so as the film has a peelable seal to the substrate.

12. The method of claim 11, wherein the substrate is formed of an olefin based polymer.

13. The method of claim 11, wherein the substrate is formed of polypropylene, polyethylene and combinations thereof

14. The method of claim 11, wherein the olefin based polymer comprises a propylene based random copolymer.

15. The method of claim 11, wherein the olefin based polymer is selected from polypropylene, polyethylene, copolymers thereof and combinations thereof

16. The method of claim 11, wherein the polymeric composition comprises from about 70 wt. % to about 99 wt. % olefin based polymer.

17. The method of claim 11, wherein the polymeric composition comprises from about 1 wt. % to about 10 wt. % polylactic acid.

18. The method of claim 11, wherein the polymeric composition further comprises a reactive modifier.

19. The method of claim 18, wherein the polymeric composition comprises from about 1 wt. % to about 10 wt. % reactive modifier.
